(19) United States
(12) Patent Application Publication
(10) Pub. No.: US 2007/0269327 A1
(43) Pub. Date: Nov. 22, 2007

(54) Constant Pressure Type and Fully Enclosed Scroll Compressor for Vehicle

(75) Inventor: Yonggui Qian, Nanjing (CN)

Correspondence Address: GLOBAL IP SERVICES, 2462 ROCK ST., APT. 6, MOUNTAIN VIEW, CA, 94043, US

(73) Assignee: Nanjing Aotecar Refrigerating Compressor Co., Ltd., Nanjing (CN)

(21) Appl. No.: 11/751,130

(22) Filed: May 21, 2007

(30) Foreign Application Priority Data
May 22, 2006 (CN) 200610040514.5

(51) Int. Cl. F01C 1/02; F03C 2/00; F04C 29/00

(52) U.S. Cl. 418/55.1; 418/55.6; 418/270

(57) ABSTRACT

Aiming at settling the problem of unstable pressure for the existing vehicle scroll compressor and the problem of being unable to create electric automobile air conditioner compressors after appropriate alteration, this invention offers a new type that delivers constant pressure and a fully enclosed scroll compressor. It includes a static disc (1), dynamic disc (2) and crankshaft (5). The static disc (1) is fixed in the case (6). The type line end of the dynamic disc (2) penetrates into the static disc (1). The dynamic disc (2) is connected with the crankshaft (5). The crankshaft (5) is connected with the drive unit (13). The air outlet (9) that connects with the high pressure cavity (10) in the static disc (6) is set on the case (6). The air inlet (8) that connects with the air intake cavity 18 of the static disc (1) is set on the other end of the case (6). Its feature is as follows: the high pressure cavity (10) is connected with a zoom type unloading valve (11) that has adjustable pressure. The air inlet end of this zoom type unloading valve (11) connects with the high pressure cavity (10), and the air outlet end of this zoom type unloading valve connects with the air inlet (8) by air pipe (16). It successfully settles the problem of delivering constant pressure and pressure relief for existing scroll compressors. It can be used in both fuel vehicles and electric automobiles after appropriate alteration.

### CROSS REFERENCE TO THE RELATED PATENT APPLICATION

This application claims the priority of the Chinese patent application No. 200610040514.5, filing date May 22, 2006.

### FIELD OF THE INVENTION

This invention relates to an air conditioner compressor for vehicles, and especially to a fully enclosed scroll compressor for vehicle air conditioners that are suitable for both fuel vehicles and electric motor cars.

### BACKGROUND OF THE INVENTION

Currently, the requirements on environment protection are becoming higher and higher, and the energy shortage is more and more serious. Therefore, various countries are making full efforts to develop electric automobiles. In the near future, electric automobiles will replace gasoline and diesel automobiles to become the mainstream automobile. Air conditioners in vehicles, which are the most important equipment for the comfort of automobile, will change with the change of the driving manner. An electric motor compressor will replace the traditional engine-powered compressor. As the existing compressors for vehicles cannot meet the demand of electric automobiles, a new electric motor compressor must be developed. While existing household air conditioner compressors are driven by electric motors, they cannot be applied in electric automobiles because of the difference in working conditions. Therefore, it is imperative under this situation to develop a vehicle compressor that is suitable for electric automobile.

Scroll compressors are the preferred air conditioner compressors for automobiles because of such advantages as small size, large power, good safety, high reliability, etc. Scroll compressors are the preferred air conditioner compressors for electric automobiles, but when they are operating, such factors as instable pressure will influence their normal operation, and will occur because of their structure. Therefore, pressure relief must be carried out at an appropriate time. Currently, they are discharged into the air for pressure relief. They will pollute the air, and they will influence the lubrication, working efficiency and service life of the compressor. This problem must be settled in order to apply them in electric automobiles. The existing scroll compressor for vehicles adopts the driving manner of a clutch plus belt, and it has a partially closed structure. If it is driven by electricity, its case structure will become rather complicated, and the production cost is rather high. These factors limit the research and development of fully enclosed scroll compressors for electric automobiles.

Therefore, the improvement on the existing vehicle scroll compressors will enable it with constant pressure and a change of driving manner from mechanical drive into electric (storage battery) drive after appropriate improvement. In other words, the scroll compressors that can be used on electric automobiles have become a top priority task for the automobile scroll compressor manufacturing industry.

### SUMMARY OF THE INVENTION

The aim of this invention is to design a type with constant pressure and a fully enclosed scroll compressor so as to settle the problem of unstable pressure for vehicle scroll compressors and the problem of being unable to become an electric automobile air conditioner compressor after appropriate alterations.

The technical scheme of this invention is as follows:

This type delivers constant pressure and a fully enclosed scroll compressor for vehicles, and it includes a static disc 1, dynamic disc 2 and crankshaft 5. The static disc 1 is fixed in the case 6. The type line end of the dynamic disc 2 penetrates into the static disc 1. The other end of the dynamic disc 2 is connected with one end of the crankshaft 5. The other end of the crankshaft 5 is connected with the drive unit 13. The air outlet 9 that connects with the high pressure cavity 10 is set on the end of the case 6 that is close to the static disc 1. The high pressure cavity 10 connects with the high pressure discharge outlet 17 of the static disc 1. The air inlet 8 that connects with the air intake cavity 18 of the static disc 1 is set on the other end of the case 6. Its feature is as follows: the high pressure cavity 10 is connected with a zoom type unloading valve 11 that has an adjustable pressure. The air inlet end of this zoom type unloading valve 11 connects with the high pressure cavity 10, and the air pipe 16 connects with the air inlet 8.

The drive unit 13 is composed of a motor stator 3, motor rotor 4 and motor case 7. One end of the crankshaft 5 is connected with the motor rotor 4. The motor rotor 4 is installed in the motor stator 3. The motor stator 3 is installed in the motor case 7. The end of the motor case 7 that is opposite to the case 6 is connected through a flange structure. The air inlet 8 is located on the motor case 7. The air outlet 9 is located on the end of the case 6 that is close to the static disc 1. The zoom type unloading valve 11 is installed on the side of the case 6 that is close to the air outlet 9. The flanged disc 12 in the flange structure is either located on the case 6 or on the motor case 7. A positioning latch or positioning hole 19 is set on the flanged disc 12, and a suitable positioning hole or positioning latch 20 is set on the corresponding case base.

Cooling plates 21 are installed on the motor case 7, and an air pipe 16 penetrates into the cooling plates 21.

The air pipe 16 is a helical cooling pipe.

Cooling plates are installed on the case 6, and an air pipe 16 penetrates into the cooling plates.

The drive unit 13 can also be composed of belt wheel 14 and clutch 15. The other end of the crankshaft 5 extends outside the case 6. A belt wheel 14 is installed on the end of the crankshaft 5 that extends outside the case 6. The clutch 15 is installed on the side with the belt wheel 14. The air inlet 8 is located on the end of the case 6 that is close to the belt wheel 14. The air outlet 9 is located on the end of the case 6 that is close to the static disc 1. The zoom type unloading valve 11 is installed on the side of the case 6 that is close to the air outlet 9.

This invention enjoys the following advantages:

1. It settles the problem of delivering constant pressure and environment protection of scroll compressors. It can be used in both fuel vehicles and electric drive vehicles.

2. It settles the problem of excessive pressure discharge for electric motor compressors. It will not cause excessive temperatures for the compressor because of the duty cycle operation of the high temperature medium, which will influence the normal operation of the compressor. When the high temperature medium is cycling outside the compressor body, forced cooling is carried out on it. The medium will enter the cycling process after cooling. In this way, the temperature of the air inlet can be decreased, the consumption of lubricating oil can be reduced greatly, and the overhaul life can be prolonged.

3. The structure is simpler. When it is used as the compressor for electric automobiles, the case can be divided into a two-segmentation structure, which can be connected automatically through the positioning latch, hole and flange. In this way, the quantity of machine work can be reduced, and the assembly time can be greatly decreased. Thus, it saves the cost.

### BRIEF DESCRIPTION OF DRAWINGS

FIG. 1 is one of the structural sketch of this invention.

FIG. 2 is other one of the structural sketch of this invention.

FIG. 3 is the structural sketch of the zoom type unloading valve of this invention.

### DETAIL DESCRIPTION OF THE INVENTION

The following is the further explanation on this invention combining the structure drawing and implementation example.

### Example 1

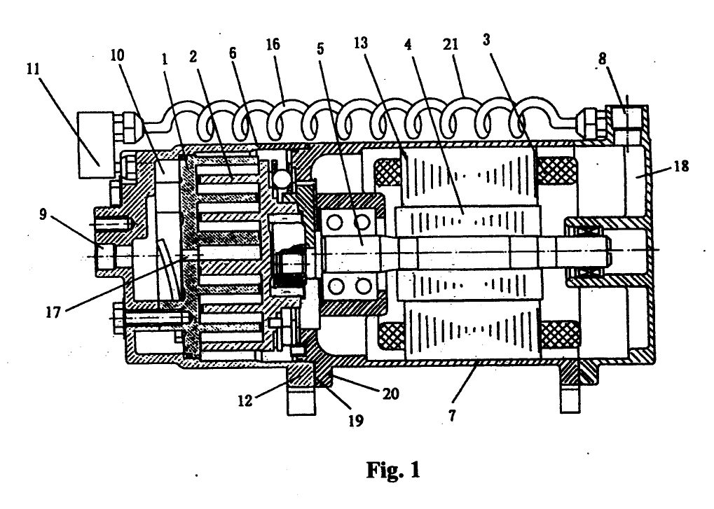

Refer to FIG. 1 and FIG. 3.

This type delivers constant pressure and a fully enclosed AC/DC scroll compressor for electric automobiles, and it includes a static disc 1, dynamic disc 2, motor stator 3, motor rotator 4 and crankshaft 5. The static disc 1 is fixed in the case 6. The type line end of the dynamic disc 2 penetrates into the static disc 1. The other end of the dynamic disc 2 is connected with one end of the crankshaft 5. The other end of the crankshaft 5 is connected with the motor rotator 4. The supporting structure of the crankshaft 5 is the same as the existing technology, and it may adopt the bearing supporting structure. The motor rotor 4 is installed in the motor stator 3. The motor stator 3 is installed in the motor case 7. The case 6 and the motor case 7 may be constructed in either a integral structure or segmentation structure. When it is in the segmentation structure, its opposite ends may adopt the flange connection structure. The flanged disc 12 may be either located on the case 6 or on the motor case 7. A positioning latch or positioning hole 19 is set on the flanged disc 12, and a suitable positioning hole or positioning latch 20 is set on the corresponding case base. The air inlet 8 is located on the motor case 7. The air outlet 9 is located on the case 6. The air outlet 9 connects with the high pressure cavity 10. The high pressure cavity connects with the high pressure discharge outlet 17 of the static disc 1. The air inlet end of the zoom type unloading valve 11 (it is a usual part, and it may be self made, purchased from the market or made according the Drawing 3) connects with the high pressure cavity 10, and the air outlet end connects with the air inlet 8 through the helical cooling air pipe 16. The length of the air pipe 16 can be increased through adopting the helical cooling pipe. Thus, the heat emission area is increased. In order to further enhance the heat emission effect during concrete implementation, cooling plates may be installed on the case 6 and motor case 7 where the cooling air pipe 16 passes to make the air pipe 16 (either in a straight shape or helical shape) to penetrate the cooling plates. In this way, the high temperature air in the air pipe 16 can be rapidly cooled through the air pipe wall and the cooling plate. Thus, after pressure relief, the high temperature air will be cooled rapidly. The zoom type unloading valve 11 can be purchased from the market or be self-designed. When necessary, it may be designed into an electric control type. It may be installed on the case 6 or at other positions.

All the unmentioned parts of this implementation example are the same as the existing technology.

### Example 2

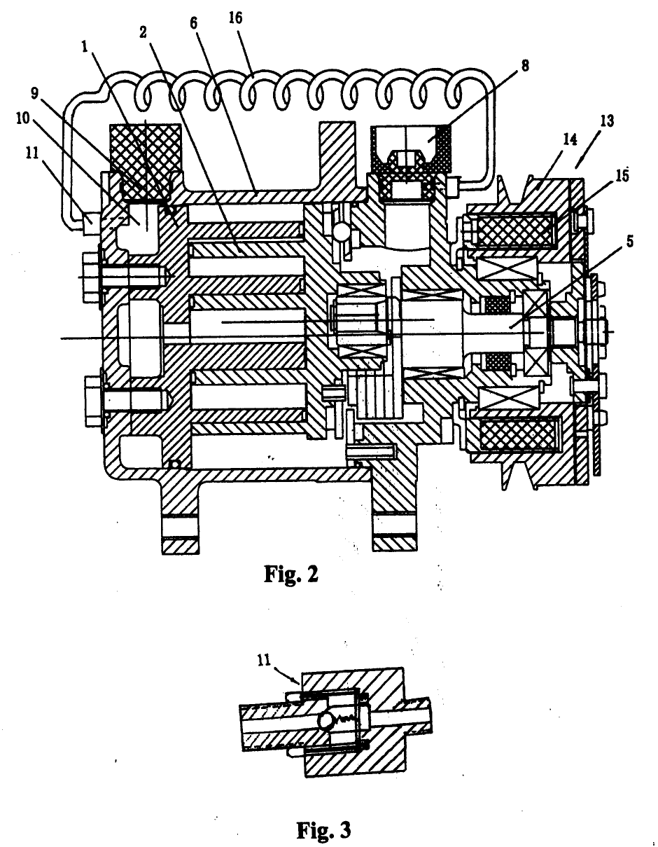

Refer to FIG. 2 and FIG. 3.

This type delivers a constant pressure and a fully enclosed scroll compressor for fuel automobiles, and it includes static disc 1, dynamic disc 2, and crankshaft 5. The static disc 1 is fixed in the case 6. The type line end of the dynamic disc 2 penetrates into the static disc 1. The other end of the dynamic disc 2 is connected with one end of the crankshaft 5. The other end of the crankshaft 5 is connected with the belt wheel 14 after extending outside the case 6. The belt wheel 14 is driven by the engine of the automobile, and the working of the belt wheel 14 is controlled by the clutch 15 that is installed the outside of the belt wheel. The supporting structure of the crankshaft 5 is the same as the existing technology, and it may adopt the bearing supporting structure. The air inlet 8 is located on the end of the case 6 that is close to the belt wheel 14. The air outlet 9 is located on the end of the static disc 1 that is closed to the case 6. The air outlet 9 connects with the high pressure cavity 10. The high pressure cavity connects with the high pressure discharge outlet 17 of the static disc 1. The air inlet end of the zoom type unloading valve 11 (it may be self made, purchased from the market or made according the Drawing 3) connects with the high pressure cavity 10, and the air outlet end connects with the air inlet 8 through the helical cooling air pipe 16. The length of the air pipe 16 can be increased through adopting the helical cooling pipe. Thus, the heat emission area is increased. In order to further enhance the heat emission effect during concrete implementation, cooling plates may be installed on the case 6 and motor case 7 where the cooling air pipe 16 passes to make the air pipe 16 (either in a straight shape or helical shape) to penetrate the cooling plates. In this way, the high temperature air in the air pipe 16 can be rapidly cooled through the air pipe wall and the cooling plate. Thus, after pressure relief, the high temperature air will be cooled rapidly. The zoom type unloading valve 11 can be purchased from the market or be self-designed. When necessary, it may be designed into an electric control type. It may be installed on the case 6 or at other positions.

All the unmentioned parts of this implementation example are the same as the existing technology.

The working process of this invention is as follows:

During normal operation, driven by the motor rotator or the belt wheel, the crankshaft of the scroll compressor will rotate, and after the circulating gas is compressed in the compression cavity between the static disc and dynamic disc through the air inlet 8, it will be discharged from the high pressure cavity 10 in the static disc 1. Then, it will enter the condenser (or evaporator) through the air outlet 9. After circulation, it will re-enter the compression cavity between the static disc and dynamic disc through the air inlet 8 for compression. For this kind of circulation, when the discharge pressure of the high pressure cavity 10 is lower than the set value of the zoom type unloading valve 11, the zoom type unloading valve 11 is at the off state, and the circulating gas will always enter the compressor from the air inlet 8. Then, it will be discharged from the air outlet 9 and enter the circulation system. After circulation, it will enter the compressor from the air inlet 8. When the pressure of gas discharged from the high pressure cavity 10 is higher than the set value of the zoom type unloading valve 11 (when the pressure outputted by the compressor is too high), some gas will enter the zoom type unloading valve 11 from the air inlet of the zoom type unloading valve 11. Then, this gas will be released from the air outlet of the zoom type unloading valve 11 and then enter the air inlet 8 through the air pipe 16. This gas will be directly compressed between the dynamic disc and static disc without the circulation in the air conditioning system, and then this gas will be released. At the same time, the rest of the high pressure gas will be normally discharged from the air outlet 9 so as to guarantee the normal operation of the air conditioning system. Some gas that is discharged from the air pipe 16 without circulating in the air conditioning system must be cooled when it directly enters the compressor from the air inlet, as its temperature is rather high. One cooling method is to increase the length of the air pipe 16, for example, adopting a helical air pipe. The other cooling method is to increase the number of cooling plates to cool the gas in the air pipe 16 through the air pipe wall and the cooling plates so as to lower the temperature of the gas when it enters the air inlet. Therefore, this invention can prevent the air pollution caused by the direct discharge of compressed air medium that contains lubricating oil into the air. This invention can also reduce the consumption of cooling medium and lubricating oil. Thus, this invention can make the operation of the compressor more stable and reliable.

What is claimed is:

1. A constant pressure type and fully enclosed scroll compressor for vehicles including a static disc fixed in a case, a dynamic disc, a crankshaft, a type line end of the dynamic disc inserting into the static disc, other end of the dynamic disc being connected with one end of the crankshaft, other end of the crankshaft being connected with a drive unit, an air outlet connected with a high pressure cavity being set on one end of the case near the static disc, the high pressure cavity connecting a high pressure discharge outlet of the static disc, an air inlet connected with an air intake cavity of the static disc being set on other end of the case, wherein the high pressure cavity being connected with a zoom type unloading valve for adjusting pressure, other end of the zoom type unloading valve connecting the air inlet through a air pipe.

2. The constant pressure type and fully enclosed scroll compressor for vehicles of claim 1, wherein the drive unit including a motor stator, a motor rotor and a motor case, one end of the crankshaft is connected with the motor rotor, the motor rotor is installed in the motor stator, the motor stator is installed in the motor case, the motor case is connected with the case through a flange structure, the air inlet is located on the motor case, the air outlet is located on the end of the case near the static disc, the zoom type unloading valve is installed on a side of the case near the air outlet.

3. The constant pressure type and fully enclosed scroll compressor for vehicles of claim 2, wherein a flanged disc of the flange structure is either located on the case or on the motor case, a positioning latch or positioning hole is set on the flanged disc, and a suitable positioning hole or positioning latch is set on the corresponding case base.

4. The constant pressure type and fully enclosed scroll compressor for vehicles of claim 2, wherein cooling plates are set on the motor case, and the air pipe penetrates into the cooling plates.

5. The constant pressure type and fully enclosed scroll compressor for vehicles of claim 1, wherein the air pipe is a helical cooling pipe.

6. The constant pressure type and fully enclosed scroll compressor for vehicles of claim 1, wherein cooling plates are set on the case, and the air pipe penetrates into the cooling plates.

7. The constant pressure type and fully enclosed scroll compressor for vehicles of claim 1, wherein the drive unit is composed of belt wheel and clutch, one end of the crankshaft extends outside the case, the belt wheel is installed on other end of the crankshaft, the clutch is installed on the side of the belt wheel, the air inlet is located on the end of the case near the belt wheel, the air outlet is located on other end of the case near the static disc, the zoom type unloading valve is installed on a side of the case near the air outlet.
